(19) United States
(12) Patent Application Publication
(10) Pub. No.: US 2009/0002463 A1
(43) Pub. Date: Jan. 1, 2009

(54) PERFORATED FLUID FLOW DEVICE FOR PRINTING SYSTEM

(76) Inventors: Jinquan Xu, Rochester, NY (US); Kenneth D. Corby, Rochester, NY (US); Zhanjun Gao, Rochester, NY (US)

Correspondence Address: David A. Novais;Patent Legal Staff, Eastman Kodak Company, 343 State Street, Rochester, NY, 14650-2201, US

(21) Appl. No.: 11/770,804

(22) Filed: Jun. 29, 2007

(51) Int. Cl. B41J 2/175

(52) U.S. Cl. 347/85

(57) ABSTRACT

A printing system includes a liquid drop ejector operable to eject liquid drops having a plurality of volumes along a first path. A fluid passage includes a wall with the wall including a perforated portion. A fluid flow source is operable to cause the fluid to flow through the passage along the perforated portion of the wall. Interaction of the fluid flow and the liquid drops causes liquids drops having one of the plurality of volumes to begin moving along a second path.

### CROSS REFERENCE TO RELATED APPLICATIONS

Reference is made to commonly-assigned, U.S. patent application Ser. No. ______ (Kodak Docket No. 93762), filed currently herewith, entitled “ENERGY DAMPING FLOW DEVICE FOR PRINTING SYSTEM,” and U.S. patent application Ser. No. ______ (Kodak Docket No. 93654), filed currently herewith, entitled “ACOUSTIC FLUID FLOW DEVICE FOR PRINTING SYSTEM.”

### FIELD OF THE INVENTION

This invention relates generally to the management of gas flow and, in particular to the management of gas flow in printing systems.

### BACKGROUND OF THE INVENTION

Printing systems incorporating a gas flow are known, see, for example, U.S. Pat. No. 4,068,241, issued to Yamada, on Jan. 10, 1978.

The device that provides gas flow to the gas flow drop interaction area can introduce turbulence in the gas flow that may augment and ultimately interfere with accurate drop deflection or divergence. Turbulent flow introduced from the gas supply typically increases or grows as the gas flow moves through the structure or plenum used to carry the gas flow to the gas flow drop interaction area of the printing system.

Drop deflection or divergence can be affected when turbulence, the randomly fluctuating motion of a fluid, is present in, for example, the interaction area of the drops (traveling along a path) and the gas flow force. The effect of turbulence on the drops can vary depending on the size of the drops. For example, when relatively small volume drops are caused to deflect or diverge from the path by the gas flow force, turbulence can randomly disorient small volume drops resulting in reduced drop deflection or divergence accuracy which, in turn, can lead to reduced drop placement accuracy.

Accordingly, a need exists to reduce turbulent gas flow in the gas flow drop interaction area of a printing system.

### SUMMARY OF THE INVENTION

According to one aspect of the present invention, a printing system includes a liquid drop ejector operable to eject liquid drops having a plurality of volumes along a first path. A fluid passage includes a wall with the wall including a perforated portion. A fluid flow source is operable to cause the fluid to flow through the passage along the perforated portion of the wall. Interaction of the fluid flow and the liquid drops causes liquids drops having one of the plurality of volumes to begin moving along a second path.

According to another aspect of the present invention, a method of printing includes providing a liquid drop ejector operable to eject liquid drops having a plurality of volumes along a first path; providing a fluid passage including a wall, the wall including a perforated portion; and causing fluid from a fluid flow source to flow through the passage along the perforated portion of the wall, wherein interaction of the fluid flow and the liquid drops causes liquids drops having one of the plurality of volumes to begin moving along a second path.

### BRIEF DESCRIPTION OF THE DRAWINGS

In the detailed description of the example embodiments of the invention presented below, reference is made to the accompanying drawings, in which:

FIG. 1A is a schematic side view of a printing system with a fluid flow device incorporating an example embodiment of the present invention.;

FIG. 1B is a schematic side view of a printing system with a fluid flow device incorporating another example embodiment of the present invention.;

FIG. 1C is a schematic side view of a printing system with a fluid flow device incorporating another example embodiment of the present invention.;

FIG. 2A is a three-dimensional view of a fluid flow device incorporating an example embodiment of the present invention;

FIG. 2B shows assembly parts of the fluid flow device incorporating an embodiment of the present invention shown in FIG. 2A;

FIG. 3A is a schematic side cross-sectional view of an example embodiment of the present invention where a wall including a perforated portion is straight along the fluid flow direction;

FIG. 3B is a schematic side cross-sectional view of an example embodiment of the present invention where a wall including a perforated portion includes a radius of curvature along the fluid flow direction;

FIG. 3C is a schematic side cross-sectional view of an example embodiment of the present invention wherein the perforated portion of the wall includes a plurality of perforated sections positioned spaced apart from each other along the passage in a direction of fluid flow;

FIG. 4A is a schematic view of an example embodiment of the present invention where the openings have a circular cross section;

FIG. 4B shows the plurality of openings arranged in an aligned two-dimensional array;

FIG. 4C shows the plurality of openings arranged in a staggered two-dimensional array;

FIGS. 5A and 5B are schematic view of an example embodiment of the present invention where the openings are slots; where FIG. 5A shows the plurality of slots arranged in an aligned two-dimensional array; and

FIG. 5B shows the plurality of slots arranged in a staggered two-dimensional array;

FIG. 5C is a slot having an elongated dimension;

FIG. 6A is a cross sectional view of a wall including a perforated portion;

FIG. 6B is an opening having a rectangular cross section;

FIG. 6C is an opening having a trapezoidal cross section;

FIG. 6D is an opening including a radius of curvature connecting the opening to the inner surface of the wall;

FIG. 6E is an opening connecting to the inner surface of the wall at a non-perpendicular angle;

FIG. 7 is a wall with a plurality of openings having an opening spacing is different from each other; and

FIG. 8 shows experimental results demonstrating the effectiveness of the fluid flow device for turbulence suppression.

### DETAILED DESCRIPTION OF THE INVENTION

The present description will be directed in particular to elements forming part of, or cooperating more directly with, apparatus in accordance with the present invention. It is to be understood that elements not specifically shown or described may take various forms well known to those skilled in the art.

The present description will be directed in particular to elements forming part of, or cooperating more directly with, apparatus in accordance with the present invention. It is to be understood that elements not specifically shown or described may take various forms well known to those skilled in the art.

The example embodiments of the present invention are illustrated schematically and not to scale for the sake of clarity. One of ordinary skill in the art will be able to readily determine the specific size and interconnections of the elements of the example embodiments of the present invention. In the following description, identical reference numerals have been used, where possible, to designate identical elements.

Although the term printing system is used herein, it is recognized that printing systems are being used today to eject other types of liquids and not just ink. For example, the ejection of various fluids such as medicines, inks, pigments, dyes, and other materials is possible today using printing systems. As such, the term printing system is not intended to be limited to just systems that eject ink.

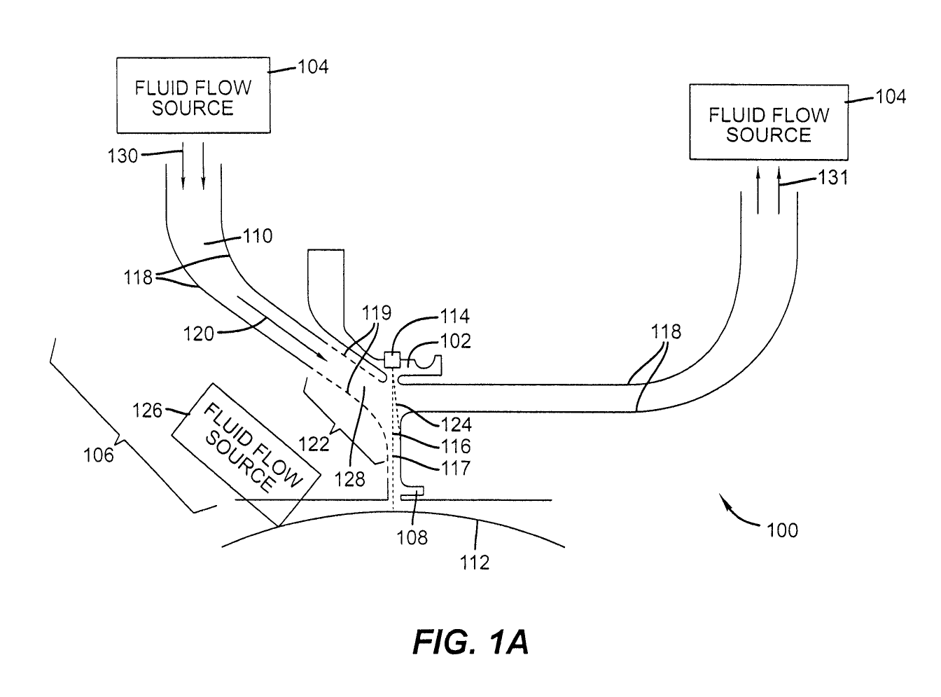

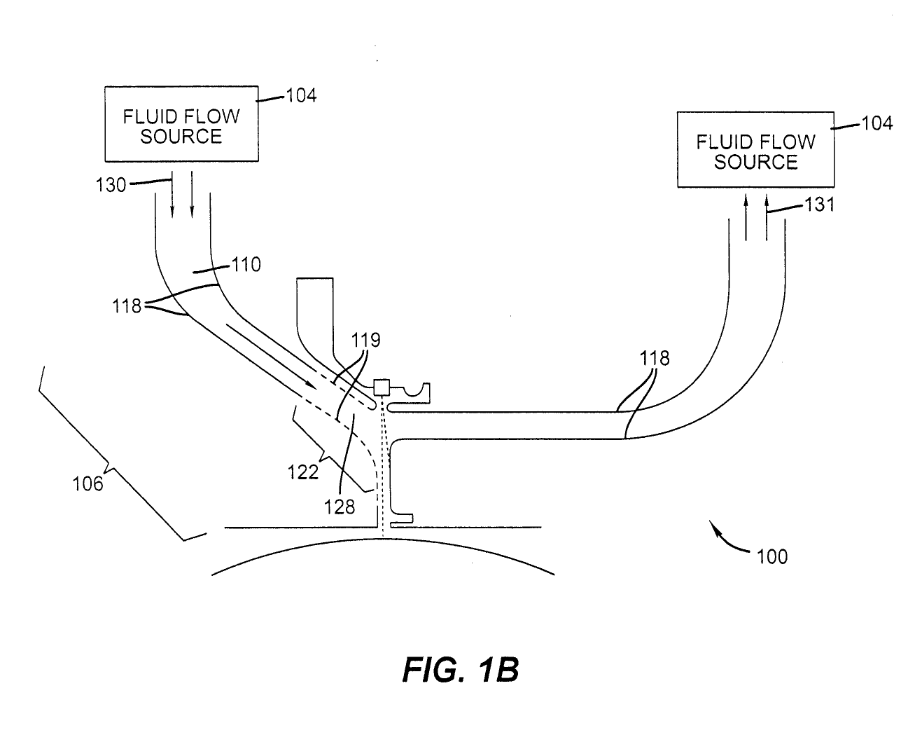

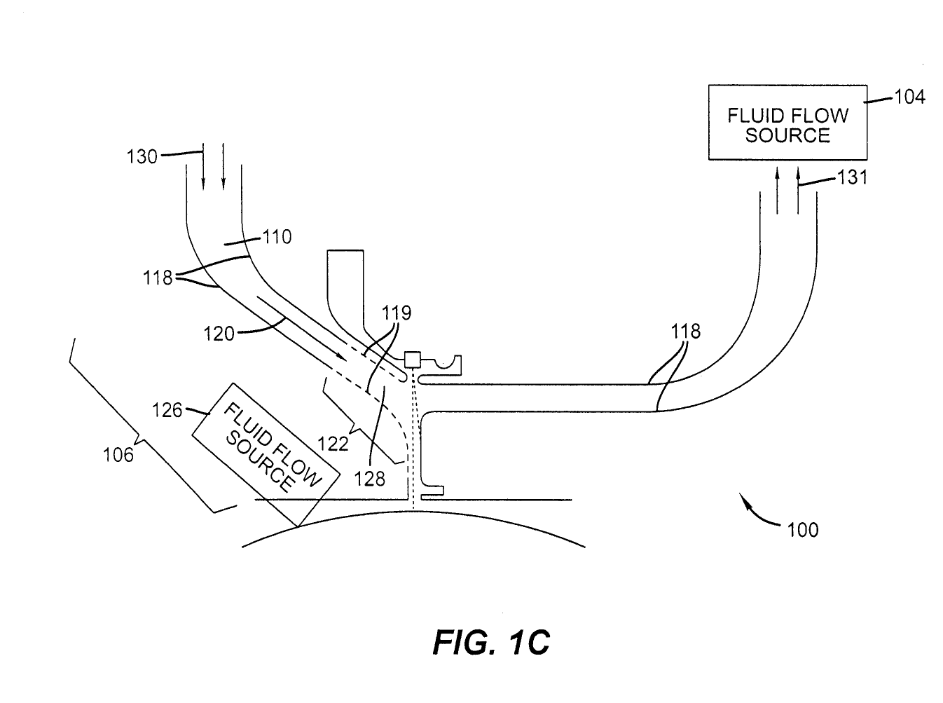

FIG. 1A is a schematic side view of a printing system with the fluid flow device incorporating an example embodiment of the present invention. The printing system 100 includes a printhead 102, a fluid flow device 106, a drop recycle system 108 and medium 112. The printhead 102 includes a drop forming mechanism 114 operable to form and eject liquid drops having a plurality of volumes traveling along a first path 116. The gas flow device 106 includes a first wall 118 and a second wall 119 that define a fluid passage 110. The second wall 119 of the fluid passage 110 includes a perforated portion 122. The perforated portion 122 of the fluid passage 110 is located adjacent to the first path 116. The first wall 118 and the second wall 119 can be straight or include a radius of curvature depending on the geometrical configuration of the printing system 100. A first fluid flow source 104 is operatively associated with the fluid passage 110 and is operable to cause a fluid flow (represented by arrows 120, hereafter) to flow through the fluid passage 110 along the perforated portion 122 of the fluid passage 110. The interaction of the fluid flow and the liquid drops causes liquid drops having one of the plurality of volumes diverge (or deflect) from the first path 116 and begin traveling along a second path 124 while liquid drops having another of the plurality of volumes remain traveling substantially along the first path 116 or diverge (deflect) slightly and begin traveling along a third path 117. Medium 112 is positioned along one of the first, second and third path while the drop recycle system 108 is positioned along another of the first, second or third paths depending on the specific application contemplated. Printheads like printhead 102 are known and have been described in, for example, U.S. Pat. No. 6,457,807 B1, issued to Hawkins et al., on Oct. 1, 2002; U.S. Pat. No. 6,491,362 B1, issued to Jeanmaire, on Dec. 10, 2002; U.S. Pat. No. 6,505,921 B2, issued to Chwalek et al., on Jan. 14, 2003; U.S. Pat. No. 6,554,410 B2, issued to Jeanmaire et al., on Apr. 29, 2003; U.S. Pat. No. 6,575,566 B1, issued to Jeanmaire et al., on Jun. 10, 2003; and U.S. Pat. No. 6,588,888 B2, issued to Jeanmaire et al., on Jul. 8, 2003. At least some the liquid drops contact medium, such as paper or other medium, while other drops are collected by the drop recycle system 108 such as a catcher. Liquid drops received by the drop recycle system 108 are circulated through a liquid recirculation mechanism commonly available for reuse.

The printing system 100 further composes a second fluid source 126. The second fluid flow source 126 is operable to cause a portion of the fluid flow flowing through the passage 110 to move through the perforated portion 122. The flow direction of the fluid flow 128 flowing through the perforated portion 122 in the second wall 119 of the fluid passage 110 can be from the inside of the fluid passage 110 to the outside of the fluid passage 110; or from the outside of the fluid passage 110 to the inside of the fluid passage 110, depending on the type of the second fluid source 126 which is determined by a specific application and the geometrical configuration of the fluid passage contemplated.

The first fluid flow source 104 can be any type of mechanism commonly used to create a gas flow. For example, the first fluid flow source 104 can be a positively pressured fluid flow source such as a fan or a blower operatively associated with an air front side 130 of the fluid passage 110. Alternatively, the first fluid flow source 104 can be of the type that creates a negative pressure or a vacuum operatively associated with the air backside 131 of the fluid passage 110. The first fluid flow source 104 can also include a combination of a positively pressured flow operatively associated with the air front side 130 of the fluid passage 110 and a negative pressure or a vacuum operatively associated with the air backside 131 of the fluid passage 110. Positioning of the first fluid flow source 104 relative to the fluid passage 110 depends on the type of the fluid flow source used. For example, when a positively pressured fluid flow source is used for the fluid flow, the first fluid flow source 104 can be located at the front side 130 of the fluid passage 110. When a negative pressure or a vacuum fluid flow source is used, the first fluid flow source 104 can be located at the backside 131 of the fluid passage 110. The gas of the first fluid flow source 104 can be air, vapor, nitrogen, helium, carbon dioxide, or other, commonly available gases. However, one example of the gas of the first fluid flow source 104 is air. Often air is the preferred gas simply due to economical reasons.

The second fluid source 126 can be a negative pressure or a vacuum operatively associated with the outside of the second wall 119 with a perforated portion 122; or a positively pressured fluid flow source operatively associated with the outside of the second wall 119 with the perforated portion 122. The flow direction of the fluid flow 128 flowing through the perforated portion 122 of the second wall 119 of the fluid passage 110 is from the inside of the fluid passage 110 to the outside of the fluid passage 110 in a case where a negative pressure or a vacuum fluid flow source 126 is used. The flow direction of the fluid flow 128 flowing through the perforated portion 122 of the second wall 119 of the fluid passage 110 is from the outside of the fluid passage 110 to the inside of the fluid passage 110 in a case where the positively pressured fluid source is used. Whether to use the negative pressure or vacuum fluid source, or to use the positively pressured fluid source depends on the fluid passage geometrical shape, the type of the first fluid source 104, and specific applications contemplated.

Typically, the gas for the second fluid flow source 126 is kept the same as the gas for the first fluid flow source 104. A example gas is air.

The material for the second wall 119 with a perforated portion can be tantalum, silicon, stainless steel, or aluminum, nickel etc., depending on mechanical integrity requirements and available perforation manufacture technology.

FIG. 1B is a schematic side view of a printing system 100 with a fluid flow device 106 incorporating an example embodiment of the present invention. FIG. 1B is similar with FIG. 1A. Referring to FIG. 1B, the first fluid flow source 104 is a positively pressured fluid flow source such as a fan or a blower operatively associated with the air front side 130 of the fluid passage 110; or the first fluid source 104 is a combination of a positively pressured fluid flow source operatively associated with the air front side 130 of the fluid passage 110 and a negative pressure or a vacuum operatively associated with the air back side 131 of the fluid passage 110. With the said first fluid flow source 104, the fluid flow can be adjusted such that a pressure differential can be built between the inside and outside of the fluid passage 110 across the perforated portion 122, with pressure inside of the fluid passage 110 is higher than pressure outside of the fluid passage 110. The pressure differential can cause a portion of the fluid flow flowing through the passage to move through the perforated portion 122 of the passage even without a second fluid flow source in operation. In the said case, the flow direction of the fluid flow 128 flowing through the perforated portion 122 of the fluid passage 110 is from the inside of the fluid passage 110 to the outside of the fluid passage 110.

FIG. 1C is a schematic side view of a printing system 100 with a fluid flow device 106 incorporating another example embodiment of the present invention. FIG. 1C is similar with FIG. 1A. Referring to FIG. 1C, the first fluid flow source 104 is a negative pressure or a vacuum operatively associated with the air backside 131 of the fluid passage 110. With the said negative pressure or a vacuum fluid flow source 104, a pressure differential may be built between the inside and outside of the fluid passage 110. To cause a flow direction of fluid flow 128 flowing through the perforated portion 122 of the fluid passage 110 from the inside of the fluid passage 110 to the outside of the fluid passage 110, the second fluid flow source 126 should be a negative pressure or a vacuum operatively associated with the outside of the second wall 119 with the perforated portion 122.

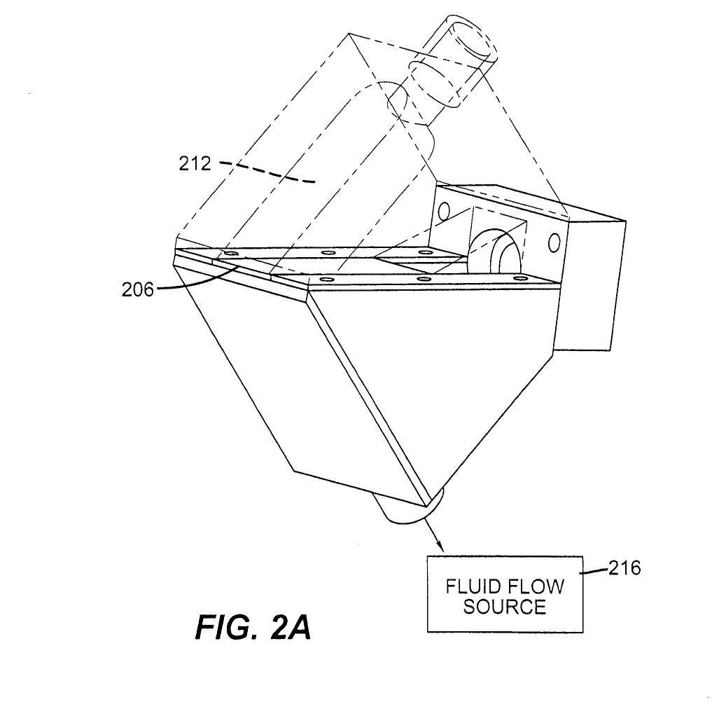

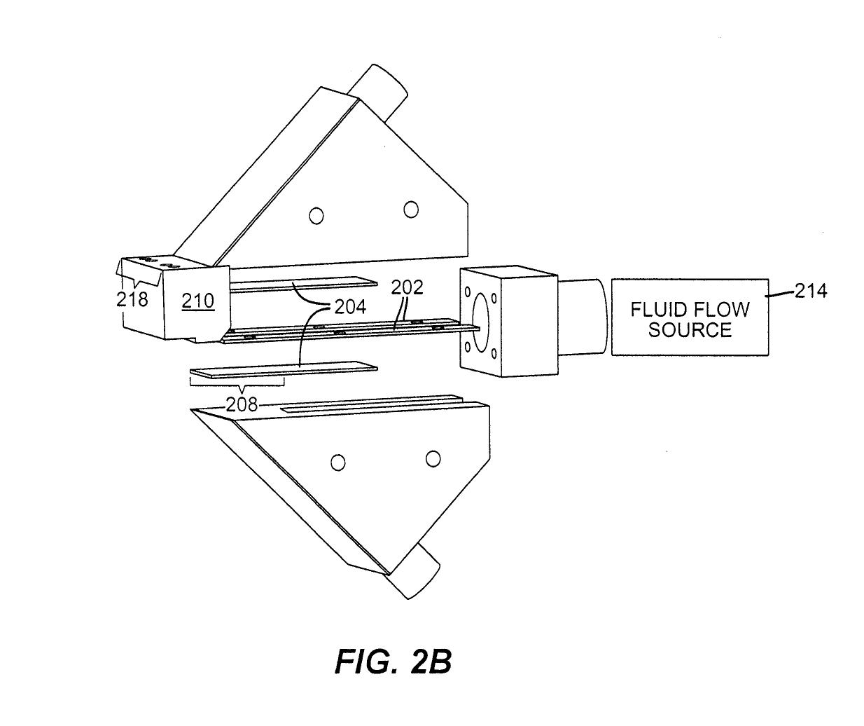

FIG. 2A shows a three-dimensional view of a fluid flow device incorporating an example embodiment of the present invention. FIG. 2B shows the collection of the parts of the fluid flow device shown in FIG. 2A for the sake of presentation clarity. The parts are assembled together by screws. Adhesives such as Epoxy may be applied as necessary for sealing purposes.

For clarity of presentation, one half of the fluid flow device in FIG. 2A shows in a sketch mode and another half of the fluid flow device in FIG. 2A shows in a solid mode. Referring to both FIGS. 2A and 2B, the two halves are mirror symmetrical. The gas flow device includes a first wall 202 and a second wall 204 that define a fluid passage 206. The second wall 204 of the fluid passage 206 include a perforated portion 208. A drop forming mechanism of a printhead 210 operable to eject drops is located adjacent to the perforated portion 208. The walls of the fluid passage are straight, and the walls are parallel to each other. The second wall 204 with the perforated portion 208 can be made from silicon wafers, titanium wafers, nickel wafers, aluminum wafers, or stainless wafers, etc. For straight walls, silicon wafers are preferred because it is relatively inexpensive; its surface is smooth; and it is reasonably rigid. However, particularly for walls having a radius of curvature, titanium is ideal for such applications, because of its rigidity and extreme smoothness. Smoothness of the wall surface is critical for such applications because fluid flow through the perforated portion leads to a thin fluid boundary layer, which becomes extremely sensitive to surface roughness. The perforated portion 208 of the second wall 204 has a plurality of holes. The holes in the perforated portion are microscopic. Diameters of these holes are less than 50 micrometers. These microscopic holes can be made using technologies, for example, chemical etching, laser drill, or electroform, etc., commonly available technology. A first fluid flow source 214 is operatively associated with the fluid passage and is operable to cause a fluid flow to flow through the passage along the perforated portion 208 of the second wall 204. A chamber 212 is operatively associated with each perforated portion 208 of the second wall 204. A second fluid flow source 216, for example, a vacuum or pressured air, operatively associated with the chamber 212 causes a portion of the fluid flow flowing through the passage 206 to move through the perforated portion 208 of the second wall 204. The chambers 212 can be made from steel, plastics or aluminum, or other suitable materials. For the fluid flow device to operate effectively, it has to be airproof along the connections of parts. Adhesives such as Epoxy may be applied for such sealing purposes. The second fluid source 216 can be the same fluid flow source or different fluid flow source for the two chambers 212. The gases of the first fluid flow source 214 and the second fluid flow source 216 are the same, and it is preferably to be air, only for an economical reason, though other gases may apply.

Typically, the width of the fluid passage is wider than the length 218 of the nozzle array of the printhead 210, to help to reduce or eliminate the boundary effects of the fluid flow to the drops. However, passage width that is equal to, or less than the length of the nozzle array of the printhead is permitted.

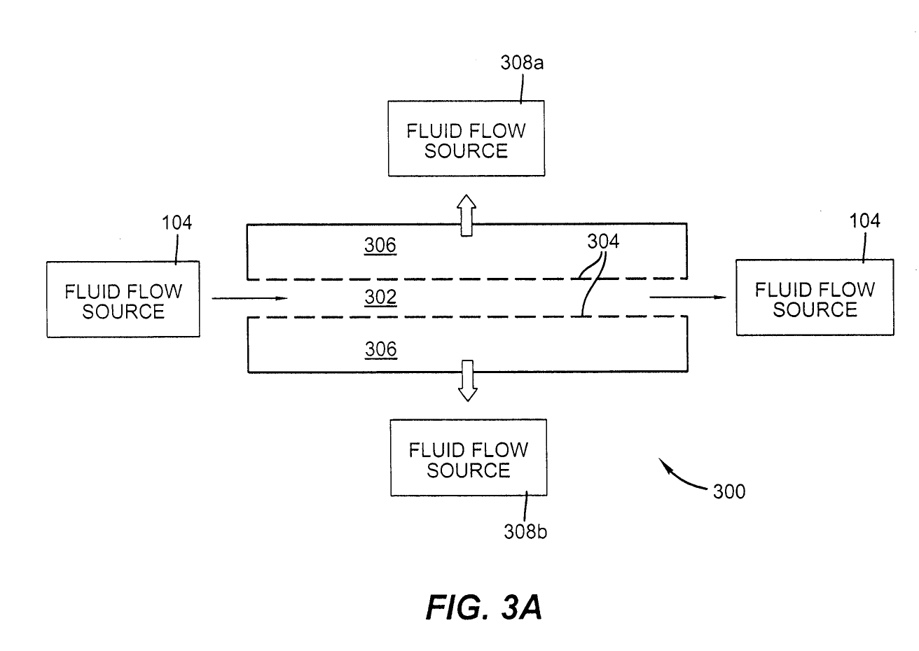

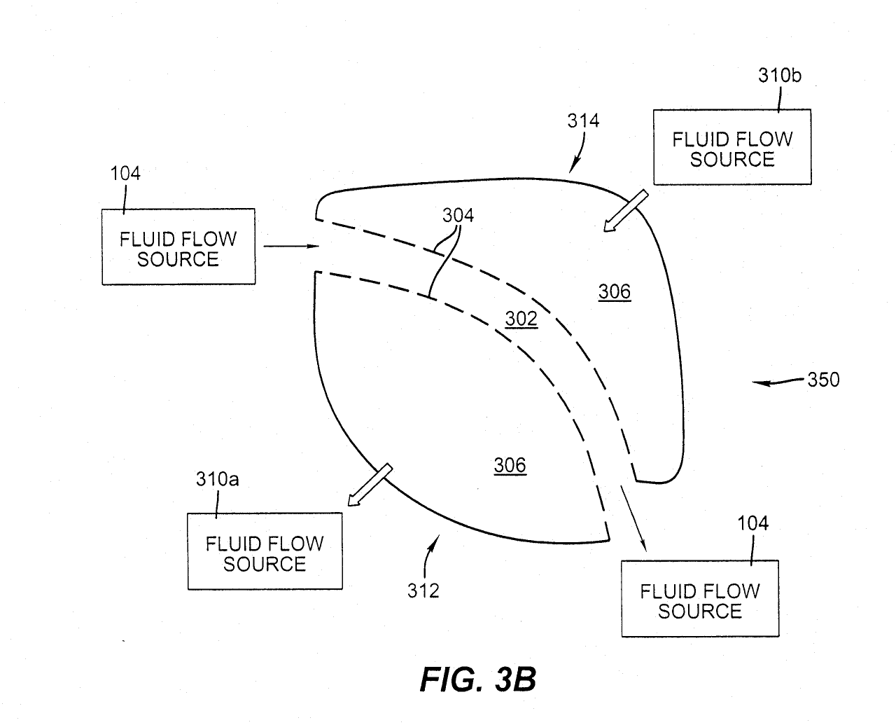

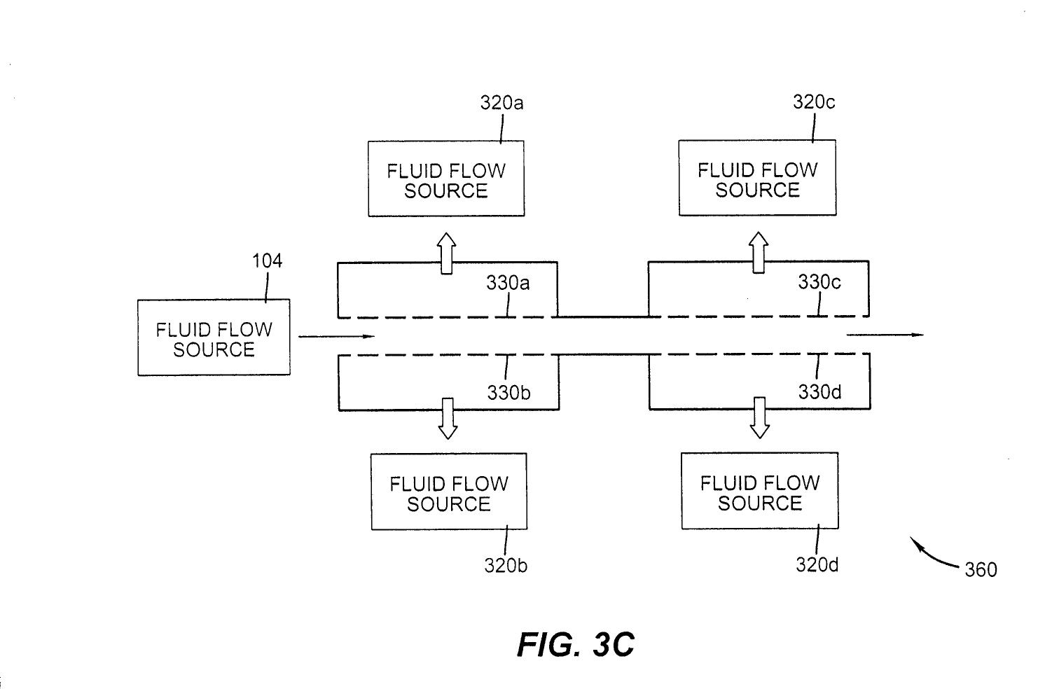

FIG. 3A shows a cross-sectional view of a portion of a fluid flow device incorporating an example embodiment of the present invention. Referring to FIG. 3A, the fluid passage 302 is straight in the direction along the fluid flow direction. A first fluid flow source 104 is operatively associated with the fluid flow device 300 and is operable to cause a fluid to flow in a direction. The fluid passage 302 includes a second wall with a perforated portion 304. The perforated openings can be holes or slots. A chamber 306 is operatively associated with the perforated portion 304. A second fluid flow source 308a and 308b, for example, a vacuum or pressured air, is operatively associated with each perforated portion 304 through the chamber 306 causes a portion of the fluid flowing through the passage to move through the perforated portion of the passage. The second fluid flow source 308a and 308b can be different. However, for a straight fluid passage, the second fluid flow source 308a and 308b are preferred to be the same.

Velocity of the fluid flow through the perforated openings should be fine-tuned to match the fluid flow velocity in the fluid passage. Although it is still an active area of research, it is believed that above a certain level of flow velocity through the perforated holes, the flow through the holes introduce disturbances to the fluid flow in the passage. As a rule of thumb, the flow velocity through the perforated openings should at least satisfy an empirical rule: the Reynolds number in the opening is less than 10. Preferably the Reynolds number should be around 1. Reynolds number, Re, defined as the ratio of inertial force to viscous force, is mathematically given by,

$$Re = \frac{du ρ}{μ} \qquad Equation 1$$

where, d is the diameter of the perforated opening such as a hole; u is mean velocity of the fluid flow through the opening; ρ is density of the fluid; and μ is fluid dynamic viscosity of the fluid. For example, for airflow through a circular hole of 20 micrometers in diameter, the mean velocity of the fluid flow through the opening should be around 0.75 m/s at a normal condition to get a Reynolds number around 1. Optimal mean flow velocities of the fluid flow through the openings for effective turbulence suppression also depends on the flow velocity in the fluid passage 302 and the geometrical shape of the fluid passage. It may be determined by experimenting through an error-and-trial method.

FIG. 3B is a cross-sectional view of a portion of a fluid flow device incorporating an example embodiment of the present invention. Referring to FIG. 3B, the fluid passage 302 has a radius of curvature. A fluid flow source 104 is operatively associated with the fluid flow device 350 and is operable to cause a fluid to flow in a direction. The fluid passage 302 including a second wall which includes a perforated portion 304. A chamber 306 is operatively associated with the perforated portion 304. A second fluid flow source 310a and 310b, is operatively associated with each perforated portion 304 through the chamber 306 causes a portion of the fluid flowing through the passage to move through the perforated portion of the passage.

Referring to FIG. 3B, the second fluid source 310a and 310b may be a negative pressure or a vacuum, or a positive pressure. It is preferred that for the perforated portion on the concave side 312 of the fluid passage 302, the flow direction of fluid flow flowing through the perforated portion 304 is from the inside of the fluid passage 302 to the outside of the fluid passage 302. In such a case, a negative pressure or a vacuum second fluid flow source 310a is preferred. It is preferred that for the perforated portion on the convex side 314 of the fluid passage 302, the flow direction of the fluid flow flowing through the perforated portion of the second wall of the fluid passage is from the outside of the fluid passage to the inside of the fluid passage. In such a case the positively pressured second fluid source 310b should be used. In short, whether to use a negative pressure or a vacuum second fluid source, or to use the positively pressured second fluid source depends on the fluid passage geometrical shape and applications contemplated. The first fluid flow source 104 can be any type of mechanism commonly used to create a gas flow. For example, the first fluid flow source 104 can be a positively pressured fluid flow source associated with the fluid passage 302. Alternatively, the first fluid flow source 104 can be of the type that creates a negative pressure or a vacuum operatively associated with the fluid passage 302. The first fluid flow source 104 can also include a combination of a positively pressured flow operatively associated the fluid passage 302 and a negative pressure or a vacuum operatively associated with the fluid passage 302.

FIG. 3C is a schematic side cross-sectional view of an example embodiment of the present invention wherein the perforated portion of the passage includes a plurality of perforated sections positioned spaced apart from each other along the passage in a direction of fluid flow. Each perforated section includes a plurality of openings having a size that is distinct when compared to the plurality of openings of another perforated section. A first fluid flow source 104 is operatively associated with the fluid flow device 360 and is operable to cause a fluid to flow in a direction. A second fluid source 320a, 320b, 320c or 320d is operatively associated with a perforated portion 330a, 330b, 330c or 330d respectively. The second fluid source 320a, 320b, 320c, 320d may be a negative pressure or a vacuum, or a positive pressure. The second fluid source 320a, 320b, 320c, and 320d can be a same fluid source, or can be a different fluid source, depending on the fluid passage geometrical shape and applications contemplated.

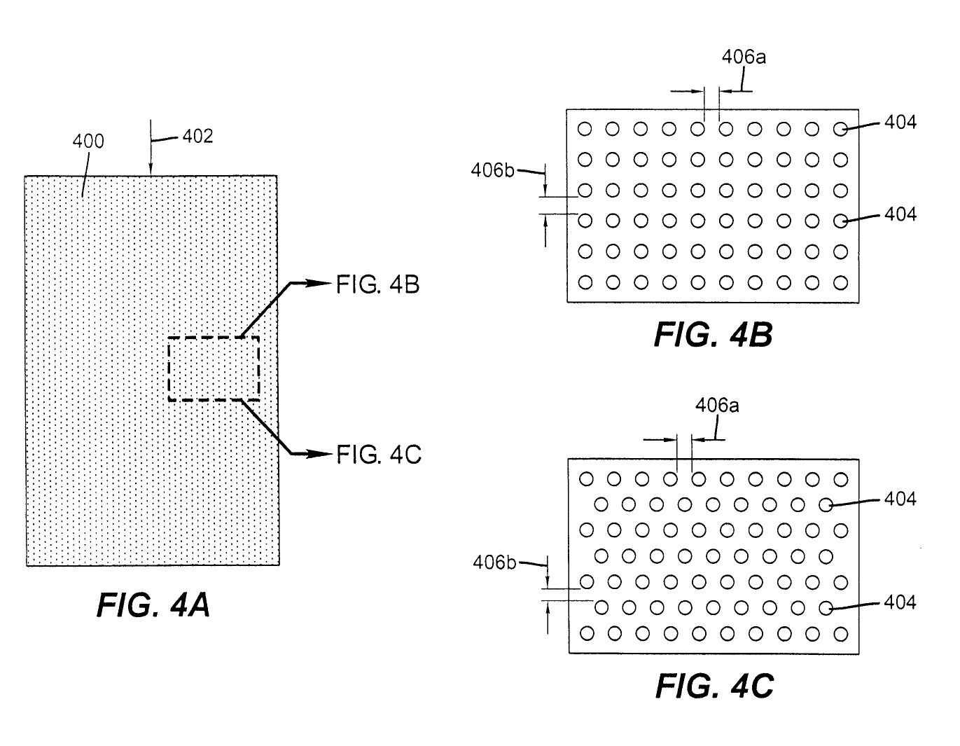

FIG. 4A shows a perforated portion of a second wall 400. A fluid flow 402 flows in a direction along the perforated portion of the wall of a passage. The perforated portion includes a plurality of holes. FIG. 4B shows the plurality of holes 404 arranged in an aligned two dimensional array; FIG. 4C shows the plurality of holes 404 arranged in a staggered two dimensional array. The holes 404 can be cut by technology such as laser beams, chemical etching, or electroform. The wall material can be tantalum, silicon, stainless steel, aluminum, or nickel etc., depending wall mechanical integrity requirement and perforation manufacture technology available. The thickness of the wall, preferably to be thin, for example, 300 micrometer. The diameters of holes 404 are around 10-50 micrometers. Spacings 406a perpendicular to the direction of the fluid flow 402 between holes 404 are roughly around 40-100 micrometers, depending on printing drop resolution. Spacings 406b parallel to the direction of the fluid flow 402 are roughly around 40-100 micrometers, determined by the flow rate of the fluid flow 402 in the passage. The shape of the holes 404 can be circular, elliptic, square or even irregular shapes such as triangular when viewed in a plane parallel to the wall 404. However, circular shapes are preferred.

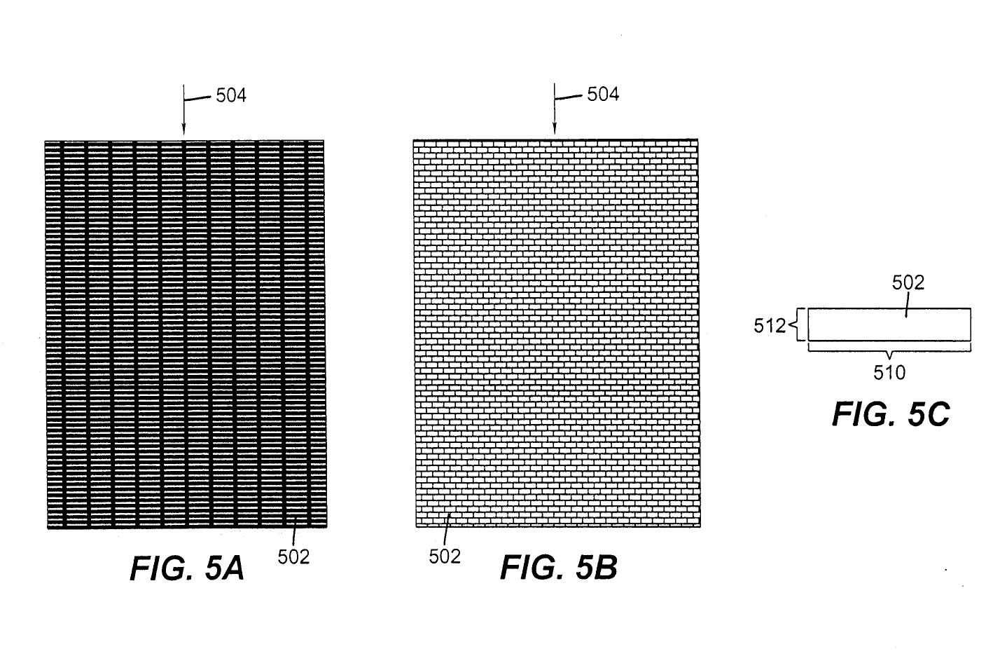

FIGS. 5A and 5B show perforated portions of a second wall. The openings of the perforated portions are slots 502. A fluid flow 504 flows in a direction along the perforated portion. FIG. 5A shows the plurality of slots 502 arranged in an aligned two dimensional array; FIG. 5B shows the plurality of slots 502 arranged in a staggered two dimensional array. FIG. 5C shows an individual slot 502. The length 510 and width 512 of the slot 502 are in an order of tens to hundreds of micrometers. For example, a slot of 20 micrometers in width and 200 micrometers in length works. Another criterion to determine the slot size is Reynolds number in the slot, Reₕ. Empirically, for a slot of length h and width w, should satisfy,

$$\frac{h}{w} {Re}_{h} < 0.01 \qquad Equation 2$$

The length of slots can be greater than the width of the slots; and the length of the slots can also be shorter than the width of the slots. Typically, the elongated dimension of the slots 502 is perpendicular to the direction of the fluid flow 504 through the passage. The thickness of the wall, preferably to be thin, for example, 300 micrometer. The spacing between the slots can be varied from tens micrometers to hundreds micrometers depending the flow rate of the fluid flow in the fluid passage and printing drop resolution. The material of the wall can be silicon, stainless steel, or nickel. The slots 502 can be manufactured using techniques, for example, laser drill, chemical etching, or electroform. The surface along the fluid flow side should be polished to minimize roughness of the walls to mitigate flow perturbation that may induce.

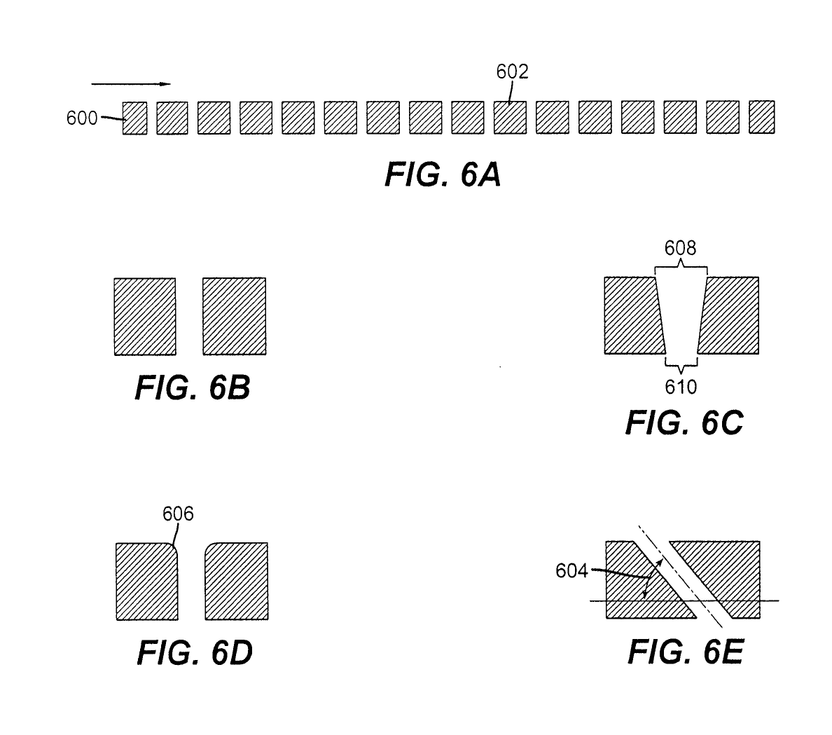

FIG. 6A shows a cross-sectional view of a perforated portion of a second wall of a fluid passage. The wall 600 has an inner surface 602. FIG. 6B is an opening having a rectangular cross section when viewed in a plane perpendicular to the inner surface 602 of the wall 600; FIG. 6C is an opening having a trapezoidal cross section when viewed in a plane perpendicular to the inner surface 602 of the wall 600; The side 608 of the opening along the inner surface 602 is larger than the size 610 along the other side; FIG. 6D is an opening including a radius of curvature 606 connecting the opening to the inner surface 602 of the wall 600 when viewed in a plane perpendicular to the inner surface 602 of the wall 600; FIG. 6E is an opening connecting to the inner surface 602 of the wall 600 at a non-perpendicular angle 604 when viewed in a plane perpendicular to the inner surface 602 of the wall 600.

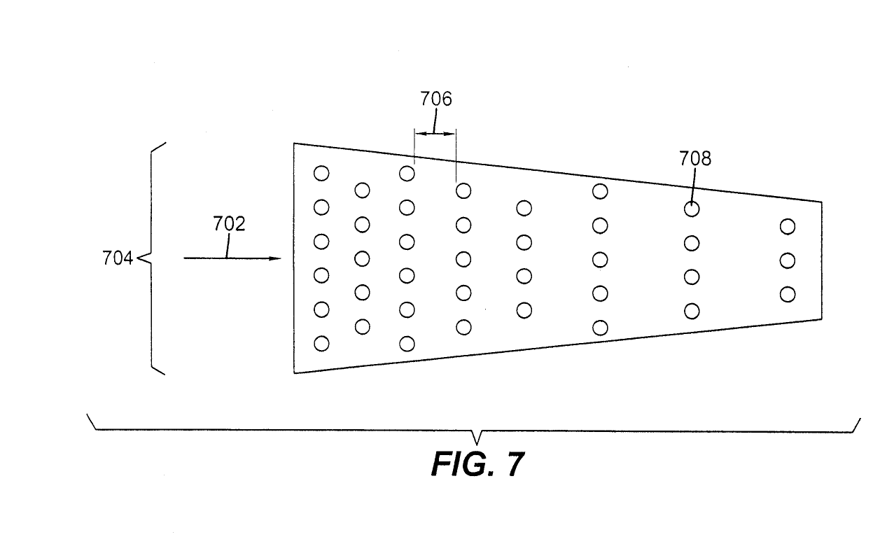

FIG. 7 is a wall with a plurality of openings 708 having an opening spacing is different from each other. FIG. 7 shows that along the fluid flow 702 direction, the width 704 of the wall is tapering. Examples of some these types of devices are described in copending U.S. patent application Ser. No. 11/744,987 the disclosure of which is incorporated by reference herein. In such an application, the spacings 706 between the perforated openings 708 are varied to accommodate the tapering shaped fluid passage. Along the fluid flow direction, the spacing 706 between the perforated holes 708 downstream is typically larger than the spacing 706 between the perforated holes upstream.

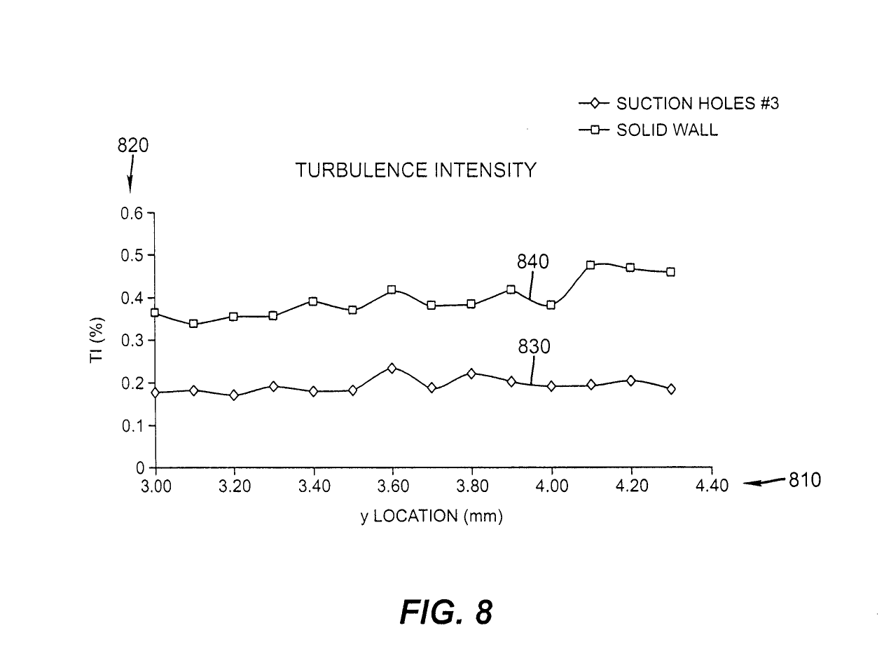

FIG. 8 shows experimental results of a flow device with and without implementation of the present invention. The test flow device is shown in FIG. 2B. For comparison purposes, in one case, the walls are solid walls without any perforated holes. In a comparison case, the walls with perforated holes are incorporated. A positively pressure fluid flow source is operatively associated with the flow device. A SMARTTUNE™ Constant Temperature Anemometer (Model IFA300, Manufactured by TSI incorporated) is used to measure the turbulence intensity near the spots adjacent to the printhead. Turbulence intensity, academically defined as the ratio of root-mean-square of fluid flow velocity fluctuations over the mean fluid flow velocity, is adopted to measure turbulence level. According to its definition, high turbulence intensity value suggests high turbulence, and vice verse. It is believed the higher turbulence intensity, the more adversary turbulence effects on drop placement on medium.

For the experiment, the wall is made from silicon wafer of 300 micrometer in thickness. Infotonics Incorporated manufactured the walls with the perforated portion. The holes are chemical etched with a diameter of 20 micrometers. Holes #3 used in the experiment are stagger-aligned holes with a spacing of 26 micrometers along the fluid flow direction and the direction perpendicular to the fluid flow. The edges of the holes in the fluid flow side are further etched so that fluid inlets have a curvature just like what shown in FIG. 6D. Mean flow velocity in the experiments is between 20 m/s and 30 m/s. The first fluid source is positively pressured air. We take advantage of the pressure differential across the inside of the fluid passage and outside of the passage to cause the fluid flow through the perforated holes.

Referring to FIG. 8, the x-axis 810 (named “y-location (mm)”) represents the relative locations of data sampling spots; the y-axis 820 (named “TI(%)”) represents turbulence intensity. Curve 830 shows experimental results with the present invention incorporated, while curve 840 shows experimental results without an embodiment of the present invention. The experimental results shown in FIG. 8 suggest the flow device incorporated the present invention can mitigate turbulence up to 50%, a significant improvement in turbulence suppression.

The invention has been described in detail with particular reference to certain example embodiments thereof, but it will be understood that variations and modifications can be effected within the scope of the invention.

### PARTS LIST

1 equation
2 equation
100 printing system
102 printhead
104 fluid flow source
106 fluid flow device
108 drop recycle system
110 fluid passage
112 medium
114 drop forming mechanism
116 first path
117 third path
118 first wall
119 second wall
120 arrows
122 perforated portion
124 second path
126 second fluid source
126 vacuum fluid flow source
128 fluid flow
130 air front side
131 air backside
202 first wall
204 second wall
206 fluid passage
208 perforated portion
210 printhead
212 chamber
214 first fluid flow source
216 second fluid flow source
218 length
300 fluid flow device
302 fluid passage
304 perforated portion
306 chamber
308a second fluid flow source
308b second fluid flow source
310a second fluid flow source
310b second fluid flow source
312 concave side
314 convex side
320a second fluid source
320b second fluid source
320c second fluid source
320d second fluid source
330a perforated portion
330b perforated portion
330c perforated portion
330d perforated portion
350 fluid flow device
360 fluid flow device
400 second wall
402 fluid flow
404 holes
404 wall
406a spacings
406b spacings
502 slots
504 fluid flow
510 length
512 width
600 wall
602 inner surface
604 non-perpendicular angle
606 curvature
608 side
610 size
702 fluid flow
704 width
706 spacings
708 perforated openings
708 perforated holes
810 x-axis
820 y-axis
830 curve
840 curve

1. A printing system comprising:
a liquid drop ejector operable to eject liquid drops having a plurality of volumes along a first path;
a fluid passage including a wall, the wall including a perforated portion; and
a fluid flow source operable to cause the fluid to flow through the passage along the perforated portion of the wall, wherein interaction of the fluid flow and the liquid drops causes liquids drops having one of the plurality of volumes to begin moving along a second path.

2. The system of claim 1, wherein the perforated portion of the passage is located adjacent to the first path.

3. The system of claim 1, the fluid flow source operable to cause the fluid to flow through the passage being a first fluid flow source, the system further comprising:
a second fluid flow source operable to cause a portion of the fluid flowing through the passage to move through the perforated portion of the passage.

4. The system of claim 3, wherein the second fluid flow source is a negative pressure fluid flow source.

5. The system of claim 2, the wall of the passage being a first wall, the passage including a second wall, the second wall including a perforated portion.

6. The system of claim 5, the system further comprising:
a positive pressure fluid flow source operable to provide fluid flow to the passage through the perforated portion of the second wall.

7. The system of claim 5, the system further comprising:
a negative pressure fluid flow source operable to remove fluid flow from the passage through the perforated portion of the second wall.

8. The system of claim 1, wherein the perforated portion of the passage includes a plurality of perforated sections positioned spaced apart from each other along the passage in a direction of fluid flow.

9. The system of claim 8, each perforated section including a plurality of openings having a size that is distinct when compared to the plurality of openings of another perforated section.

10. The system of claim 1, the wall of the passage being a first wall, the passage including a second wall, the second wall including a perforated portion.

11. The system of claim 1, wherein the perforated portion of the wall includes a plurality of openings.

12. The system of claim 11, wherein the plurality of openings are arranged in an aligned two dimensional array.

13. The system of claim 11, wherein the plurality of openings are arranged in a staggered two dimensional array.

14. The system of claim 11, the wall of the passage including an inner surface, wherein each of the plurality of openings have a rectangular cross section when viewed in a plane perpendicular to the inner surface of the wall.

15. The system of claim 11, the wall of the passage including an inner surface, wherein each of the plurality of openings have a trapezoidal cross section when viewed in a plane perpendicular to the inner surface of the wall.

16. The system of claim 11, the wall of the passage including an inner surface, wherein each of the plurality of openings include a radius of curvature connecting the opening to the inner surface of the wall when viewed in a plane perpendicular to the inner surface of the wall.

17. The system of claim 11, the wall of the passage including an inner surface, wherein each of the plurality of openings connect to the inner surface of the wall at a non-perpendicular angle when viewed in a plane perpendicular to the inner surface of the wall.

18. The system of claim 11, the wall of the passage including an inner surface, wherein the plurality of openings have a circular cross section when viewed in a plane perpendicular to the inner surface of the wall.

19. The system of claim 18, wherein each of the plurality of openings has the same diameter when compared to each other.

20. The system of claim 1, wherein the plurality of openings include a plurality of slots.

21. The system of claim 20, the slots having an elongated dimension, wherein the elongated dimension of the slots is perpendicular to the direction of the fluid flow through the passage.

22. The system of claim 1, the perforated portion of the wall including a radius of curvature.

23. The system of claim 8, each perforated section including a plurality of openings having an opening to opening spacing that is different from the opening to opening spacing the plurality of openings of another perforated section.

24. A method of printing comprising:
providing a liquid drop ejector operable to eject liquid drops having a plurality of volumes along a first path;
providing a fluid passage including a wall, the wall including a perforated portion; and
causing fluid from a fluid flow source to flow through the passage along the perforated portion of the wall, wherein interaction of the fluid flow and the liquid drops causes liquids drops having one of the plurality of volumes to begin moving along a second path.
